(19) United States
(12) Patent Application Publication
(10) Pub. No.: US 2015/0278370 A1
(43) Pub. Date: Oct. 1, 2015

(54) TASK COMPLETION FOR NATURAL LANGUAGE INPUT

(71) Applicant: Microsoft Corporation, Redmond, WA (US)

(72) Inventors: Kevin Niels Stratvert, Seattle, WA (US); Yu-Ting Kuo, Sammamish, WA (US); Andrew Paul McGovern, Seattle, WA (US); Xiao Wei, Sammamish, WA (US); Gaurav Anand, Seattle, WA (US); Thomas Lin, Bellevue, WA (US); Adam C. Lusch, Kirkland, WA (US)

(21) Appl. No.: 14/242,394

(22) Filed: Apr. 1, 2014

(51) Int. Cl. G06F 17/30; H04L 29/08; G06F 17/28

(52) U.S. Cl. CPC G06F 17/30867; G06F 17/28; H04L 67/32

(57) ABSTRACT

One or more techniques and/or systems are provided for facilitating task completion. For example, a natural language input (e.g., “where should we eat”) may be received from a user of a client device. The natural language input may be evaluated using a set of user contextual signals, opted-in for exposure by the user for facilitating task completion, to identify a user task intent. For example, a user task intent of viewing a local Mexican restaurant menu may be identified based upon a social network post of the user indicating that the user is meeting a friend for Mexican food. Task completion functionality may be exposed to the user based upon the user task intent. For example, a restaurant app may be deep launched to display a menu of a local Mexican restaurant.

### BACKGROUND

Many users perform tasks using computing devices. In an example, a user may map directions from a current location to an amusement park using a mobile device. In another example, a user may read a book using a tablet device. Various types of input may be used to perform tasks, such as touch gestures, mouse input, keyboard input, voice commands, search query input, etc. For example, while performing a vacation booking task, a user may input a search query “Florida vacations” into a search engine, and the search engine may return a variety of vacation search results that the user may use to complete the vacation booking task.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for facilitating task completion are provided herein. In an example, a natural language input may be received from a user of a client device (e.g., a voice command “what do I wear”). The natural language input may be evaluated using a set of user contextual signals associated with the user to identify a user task intent (e.g., a user may take affirmative action to provide opt-in consent for granting access to various types of user contextual signals and/or the user may opt-out to prevent access to certain types of user contextual signals). In an example, a time user signal (e.g., a current time of 6:00 pm), a geolocation user signal (e.g., a downtown hotel location), email data (e.g., a dinner reservation email at a fancy restaurant), a user social network profile (e.g., indicating that the user is a female), and/or other information may be used to identify a user task intent of viewing formal cocktail dress ideas through a fashion app. In an example of identifying the user task intent, a user intent query may be constructed based upon the natural language input, and a task intent data structure (e.g., hosted by a remote server) may be queried to obtain a global intent candidate (e.g., what tasks users of a search engine performed after submitting search queries similar to the user intent query) that may evaluated using the set of user contextual signals to identify the user task intent.

Task completion functionality may be exposed to the user based upon the user task intent. For example, a fashion app may be executed for the user. In an example, the fashion app may be deep launched into a contextual state that may be relevant to the user. For example, a task execution context (e.g., a female clothing parameter, a formal wear parameter, and/or other contextual information/parameters) may be identified based upon the user task intent. The fashion app may be deep launched into a female clothing wear shopping interface (e.g., populated with clothing corresponding to the female clothing parameter and the formal wear parameter) based upon the task execution context. In this way, task completion functionality may be exposed to the user based upon natural language input.

In an example, a task facilitator component may be implemented on the client device for facilitating task completion (e.g., the task facilitator component may identify and/or locally utilize user contextual signals, which may promote preservation of privacy of user data). In another example, a user intent provider component may be implemented on a server, remote from the client device, for facilitating task completion (e.g., the user intent provider component may receive the natural language input and/or a user intent query derived from the natural language input, and may provide a global intent candidate and/or an instruction to expose task completion functionality to the client device).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of facilitating task completion.

FIG. 2 is a component block diagram illustrating an exemplary system for facilitating task completion.

FIG. 3 is a component block diagram illustrating an exemplary system for facilitating task completion.

FIG. 4A is an illustration of an example of revising a user task intent.

FIG. 4B is an illustration of an example of revising a user task intent.

FIG. 5A is a component block diagram illustrating an exemplary system for facilitating task completion and utilizing user feedback to train a task intent model.

FIG. 5B is a component block diagram illustrating an exemplary system for facilitating task completion and utilizing user feedback to train a task intent model.

FIG. 6 is a component block diagram illustrating an exemplary system for facilitating task completion.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for facilitating task completion are provided herein. Natural language input may be evaluated to semantically and/or contextually understand a user intent to perform a task. The natural language input may be evaluated based upon global user information (e.g., what tasks various users of a search engine performed after submitting a search query) and/or personalized user information (e.g., content currently consumed by the user, a location (e.g., GPS) of the user, an email, a calendar appointment, and/or other user contextual signals that the user has opted-in to provide for facilitating task completion). In this way, task completion functionality may be exposed to the user based upon global and/or personalized evaluations of the natural language input. For example, an application may be deep launched into a contextual state associated with a task execution context identified from the user task intent (e.g., a restaurant app may be launched into a view of a menu for a Mexican restaurant based upon a voice command “I am hungry” and user contextual signals such as a location of the user, a social network profile interest in Mexican food, etc.).

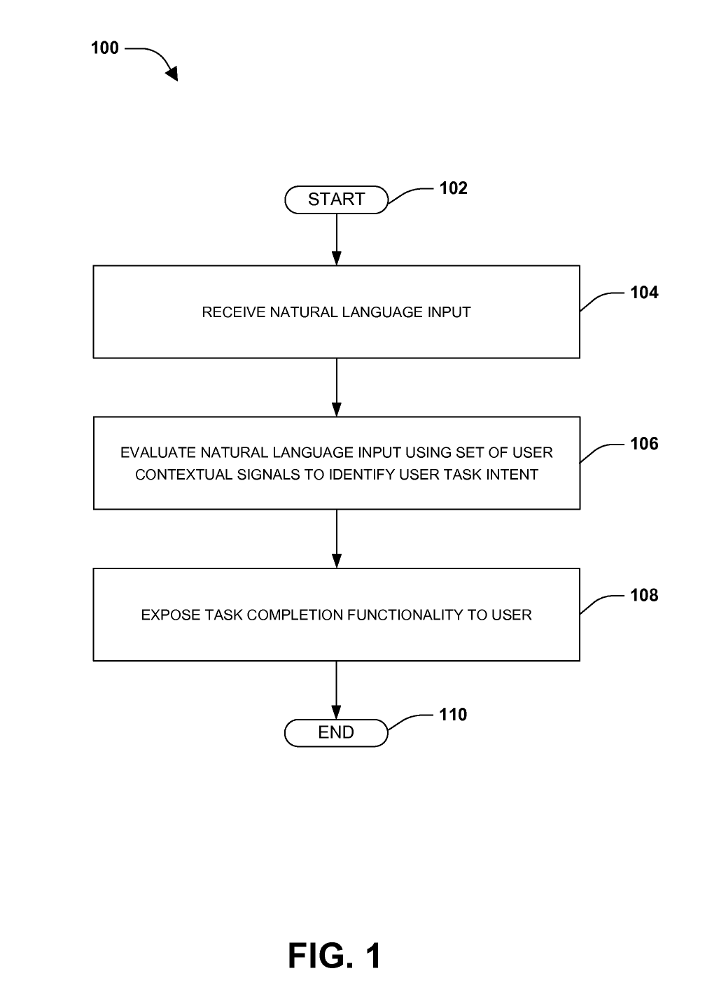

An embodiment of facilitating task completion is illustrated by an exemplary method 100 of FIG. 1. At 102, the method starts. At 104, a natural language input may be received from a user of a client device. For example, a voice command “I want to draw a car” may be received through a mobile device. At 106, the natural language input may be evaluated. In an example of evaluating the natural language input, a user intent query may be constructed based upon the natural language input (e.g., the natural language input may be parsed into words that may be selectively used and/or modified to create the user intent query). A task intent data structure may be queried using the user intent query (e.g., the user intent query may be sent to a server, remote to the client device, comprising the task intent data structure) to identify a global intent candidate. For example, the task intent data structure may be populated with one or more query to intent entries that map queries to tasks (e.g., a draw query may be mapped to an execute art application task; a car query may be mapped to a view driving video task; the car query may be mapped to a visit car review website task; etc.). The query to intent entries may be derived from community user search logs (e.g., after submitting the car query, a user may have viewed the driving video; after submitting the draw query, a user may have opened the art application; etc.). The global intent candidate may be derived from query to intent entries that match the user intent query (e.g., a draw query to art application intent entry may be identified as the global intent candidate based upon a ranking technique selecting the draw query to art application intent entry as being relevant to the user intent query).

In an example, the natural language input (e.g., and/or the global intent candidate) may be evaluated using a set of user contextual signals associated with the user to identify a user task intent. The set of user contextual signals may comprise a geolocation (e.g., the user may be at a coffee shop), a time, an executing application (e.g., a car design application), an installed application (e.g., an art drawing application), an app store application (e.g., a car review application), calendar data (e.g., a calendar entry to create a car review), email data, social network data (e.g., an indication that the user works for a car magazine company), a device form factor (e.g., desktop computer at work), a user search log (e.g., the user may have recently visited car photography websites), content consumed by the user (e.g., car photos and/or videos), community user intent for the natural language input (e.g., the global intent candidate corresponding to the draw query to art application intent entry). The set of user contextual signals may comprise information that the user may have opted-in to share for the purpose of facilitating user task completion. In an example, a user task intent to execute the art drawing application and draw a car may be identified.

In an example, a user refinement interface may be provided to the user based upon the user task intent (e.g., the user may be asked as to whether the user task intent is correct). A user task refinement input or a user acknowledgement may be received through user refinement interface. For example, the user may indicate that the user has a refined user task intent to open the car review application and create a car review with a drawing of a car. Accordingly, the user task intent may be revised based upon the user task refinement input.

At 108, task completion functionality may be exposed to the user based upon the user task intent. Task completion functionality may comprise providing the user with access to a document, an application (e.g., executing an application, deep launching an application, downloading an application from an app store, etc.), an operating system setting, a music entity, a video, a photo, a social network profile, a map, a search result, and/or a variety of other objects and/or functionality (e.g., functionality to purchase a book, functionality to reserve a table at a restaurant, etc.). In an example, the task completion functionality may comprise executing the car review application based upon the refined user task intent to open the car review application and create a car review with a drawing of a car. A task execution context may be identified based upon the user task intent (e.g., a car review creation interface of the car review application may be identified as the task execution context). The car review application may be deep launched into a contextual state associated with the task execution context (e.g., the car review application may be instructed to display the car review creation interface, as opposed to a car review reading interface). In an example, the task execution context may comprise one or more application parameters (e.g., a display car drawing interface parameter used to specify whether a car drawing interface is to be displayed through the car review creation interface). The car review application may be populated with information corresponding to the one or more application parameters (e.g., the car drawing interface may be displayed). In this way, natural language input may be used to expose task completion functionality, such as a deep launched application in a contextually relevant state, to a user.

In an example, user feedback for the task completion functionality may be identified. For example, the user may indicate that the user would have preferred to receive suggestions of car review creation apps to download from an app store as part of the task completion functionality. The user feedback may be provided to the server (e.g., the remote server hosting the task intent data structure) for training a task intent model used to populate the task intent data structure (e.g., a new query to intent entry may be created to match the natural language input and/or the user intent query to the task of previewing and downloading car review creation apps). In this way, facilitating task completion based upon natural language input may be improved. At 110, the method ends.

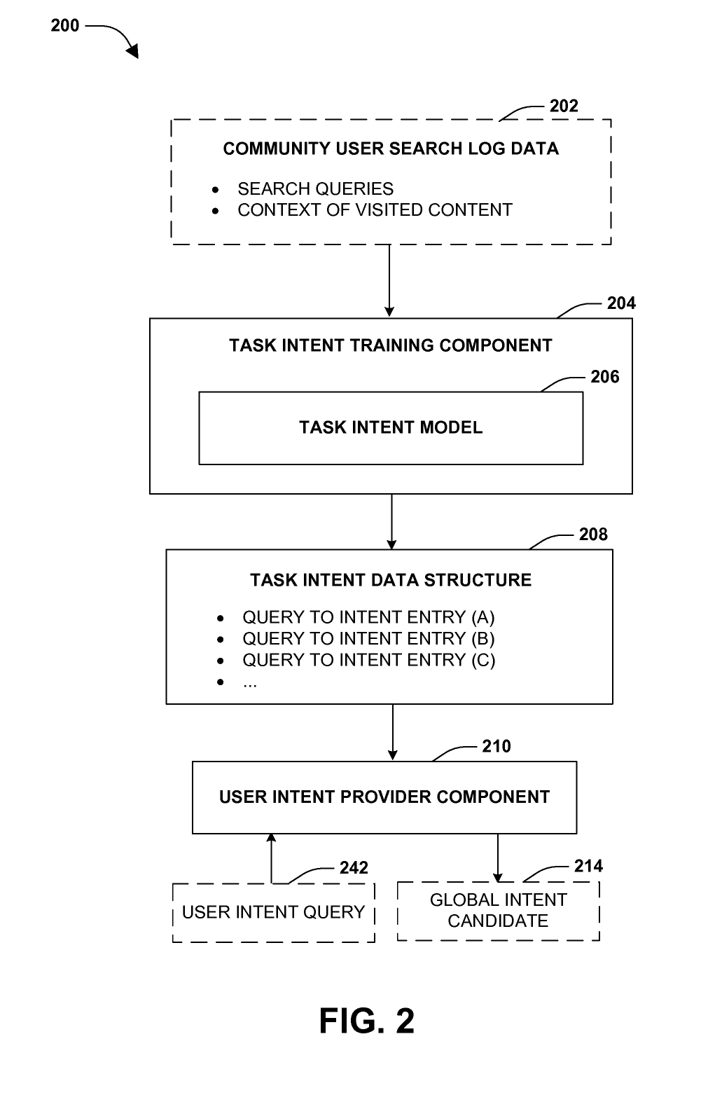

FIG. 2 illustrates an example of a system 200 for facilitating task completion. The system 200 comprises a task intent training component 204 and/or a user intent provider component 210. The task intent training component 204 may be configured to evaluate community user search log data 202 to train a task intent model 206. The community user search log data 202 may comprise globally available search queries of users and contextual information about content visited/consumed after submission of the search queries (e.g., a user may have submitting a search query “I am hungry”, and may have subsequently visited a restaurant reservation service). In this way, the task intent model 206 may be trained based upon user activity of a plurality of users, such as users of a search engine or other search interface (e.g., an operating system search charm). The task intent model 206 may be utilized to populate a task intent data structure 208 with one or more query to intent entries. A query to intent entry may match a query with a user task, which may be used to identify task completion functionality for exposure to a user from a global community perspective.

The user intent provider component 210 may be configured to receive a user intent query 242 from a client device. The user intent query 242 may be derived from a natural language input received on the client device (e.g., a user intent query to view vacation media may be derived from a natural language input of “show me my vacation”). The user intent provider component 210 may query the task intent data structure 208 using the user intent query 242 to identify a global intent candidate 214 (e.g., a global intent candidate of display photos comprising metadata associated with vacation). The global intent candidate 214 may be provided to the client device for facilitating task completion associated with a user task intent derived from the natural language input (e.g., a photo viewer app may be deep launched into a contextual state where vacation photos are displayed).

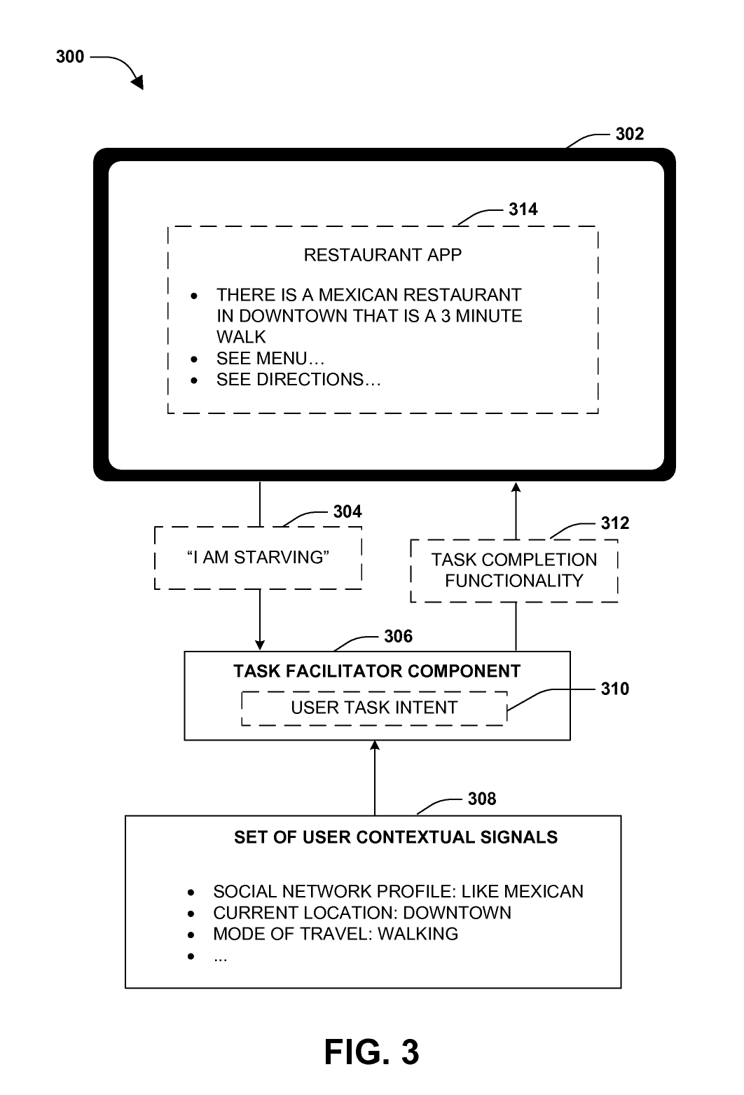

FIG. 3 illustrates an example of a system 300 for facilitating task completion. The system 300 comprises a task facilitator component 306. The task facilitator component 306 may be associated with a client device 302 (e.g., hosted locally on the client device 302, such as by a personal assistant/recommendation application, or hosted remotely such as by a cloud based recommendation service). The task facilitator component 306 may receive a natural language input 304 from a user of the client device 302. For example, the natural language input 304 of “I am starving” may be received as a voice command. The natural language input 304 may be evaluated using a set of user contextual signals 308 associated with the user to identify a user task intent 310. In an example, the user task intent 310 may correspond to an intent to open a restaurant app and view Mexican restaurant information, which may be based upon a social network profile indicating that the user likes Mexican food, a current location of Downtown, a walking mode of travel, and/or other user contextual signals (e.g., where the user has opted-in to have such signals be used as provided herein). In another example, a user intent query may be constructed based upon the natural language input, and may be used to query a task intent data structure (e.g., the task intent data structure 208 illustrated in FIG. 2) to identify a global intent candidate (e.g., indicating what tasks a community of users performed after submitting search queries similar to the user intent query and/or natural language input 304), which may be used to identify the user task intent 310.

The task facilitator component 306 may be configured to expose task completion functionality 312 to the user. For example, the task completion functionality 312 may correspond to deep launching a restaurant app 314. The current location of the user may be used to identify a set of Mexican restaurant entity candidates corresponding to the user task intent 310. A Mexican restaurant entity candidate may be selected from the set of Mexican restaurant entity candidates based upon a proximity of the Mexican restaurant entity candidate to the current location of the user. In this way, the restaurant app 314 may be deep launched where information associated with the Mexican restaurant entity candidate is populated within the restaurant app 314 (e.g., walking directions, a menu, etc.). In this way, the restaurant app 314 is deep launched into a contextually relevant state based upon the natural language input 304 and/or the set of user contextual signals 308.

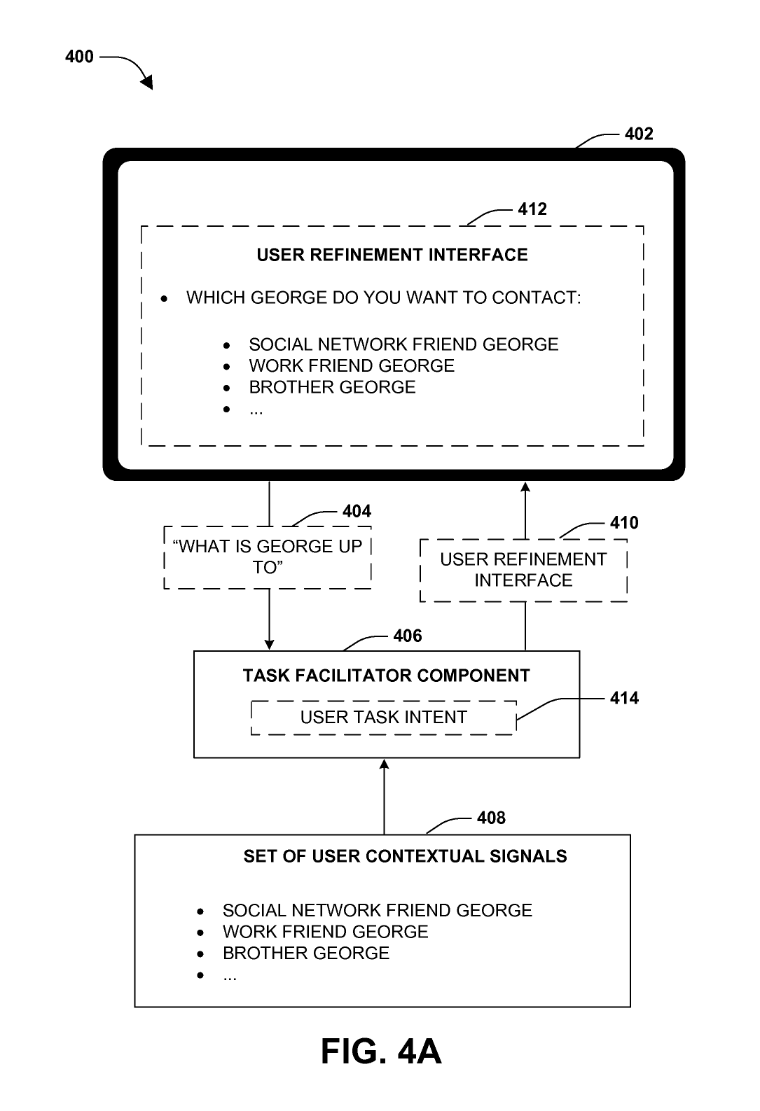

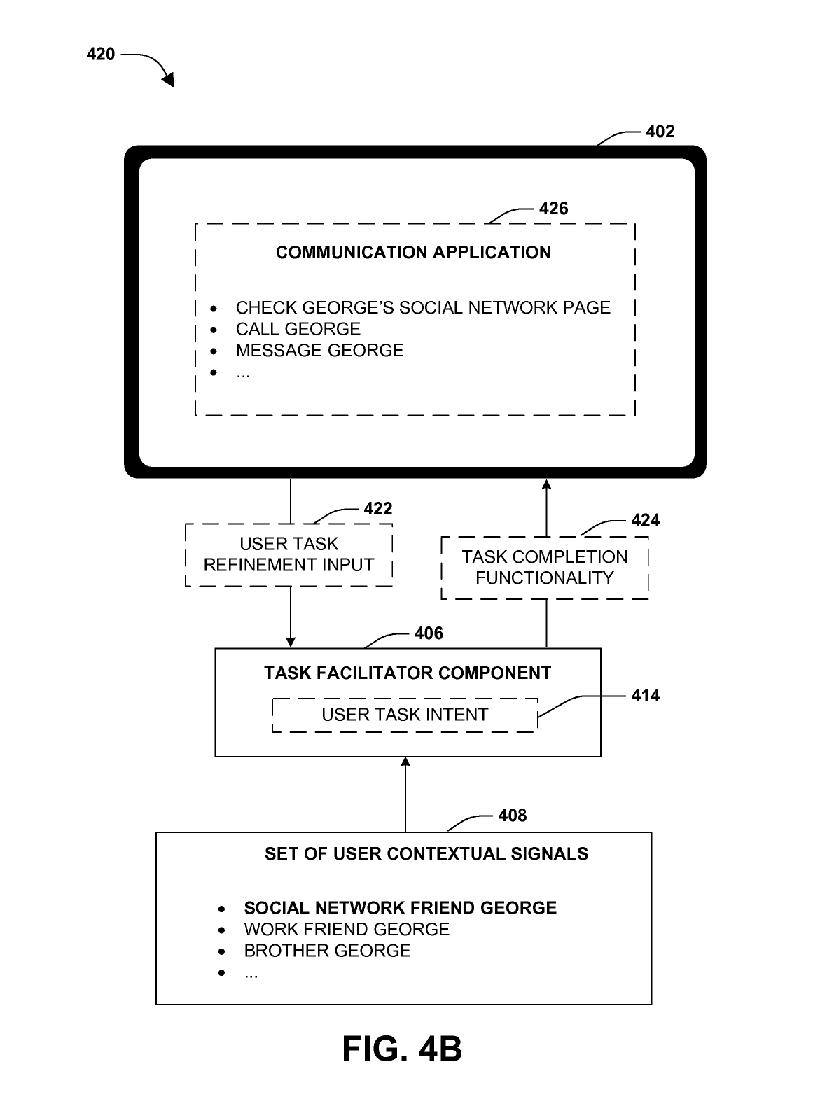

FIGS. 4A and 4B illustrate examples of revising a user task intent. FIG. 4A illustrates an example 400 of a task facilitator component 406 receiving a natural language input 404 of “what is George up to”. The task facilitator component 406 may evaluate the natural language input 404 based upon a set of user contextual signals 408 (e.g., a social network friend George contact, a work friend George contact, a brother George contact, etc.) to identify a user task intent 414 to communicate with a user named George. The task facilitator component 406 may provide 410 a user refinement interface 412 to the user based upon the user task intent 414 (e.g., because multiple users are named George). The user refinement interface 412 may request the user to specify which George to contact.

FIG. 4B illustrates an example 420 of the task facilitator component 406 receiving a user task refinement input 422 through the user refinement interface 412. The user task refinement input 422 may specify that the social network friend George is to be contacted. The task facilitator component 406 may revise the user task intent 414, and may exposed task completion functionality 424 to the user based upon the revision to the user task intent 414. For example, a communication application 426 may be deep launched into a communication hub for contacting the social network friend George.

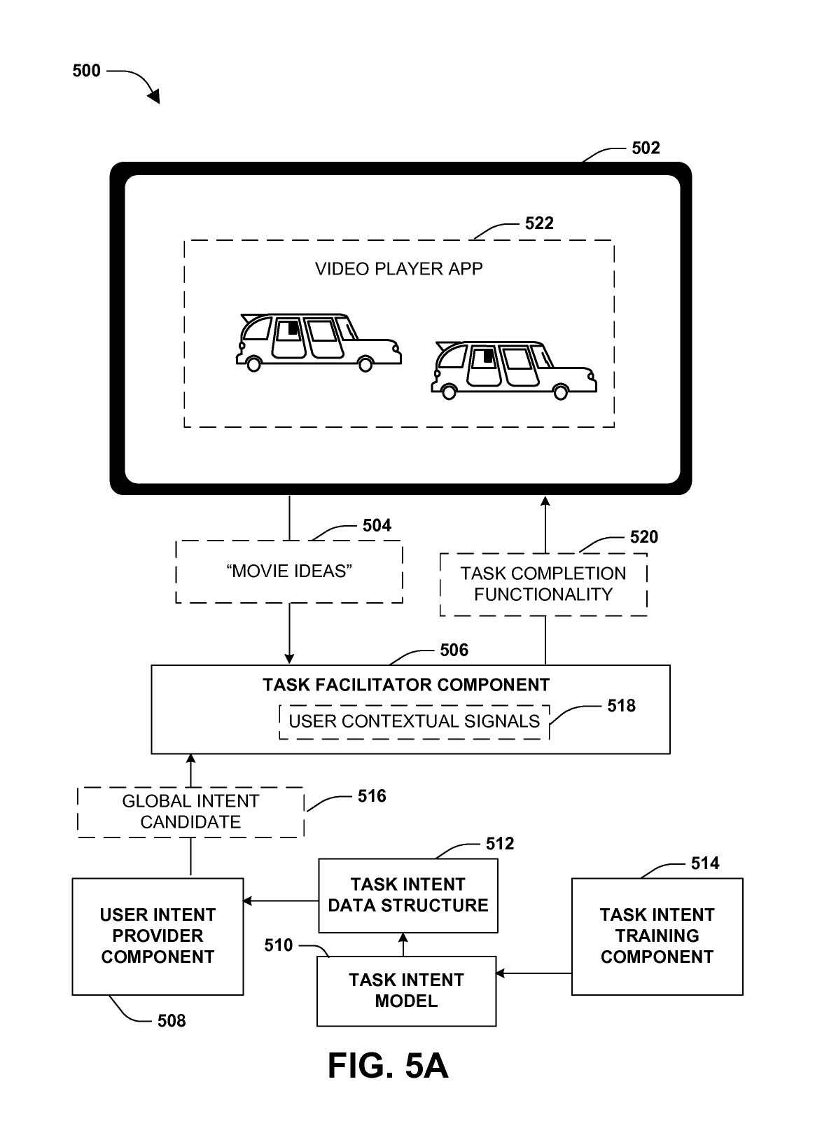

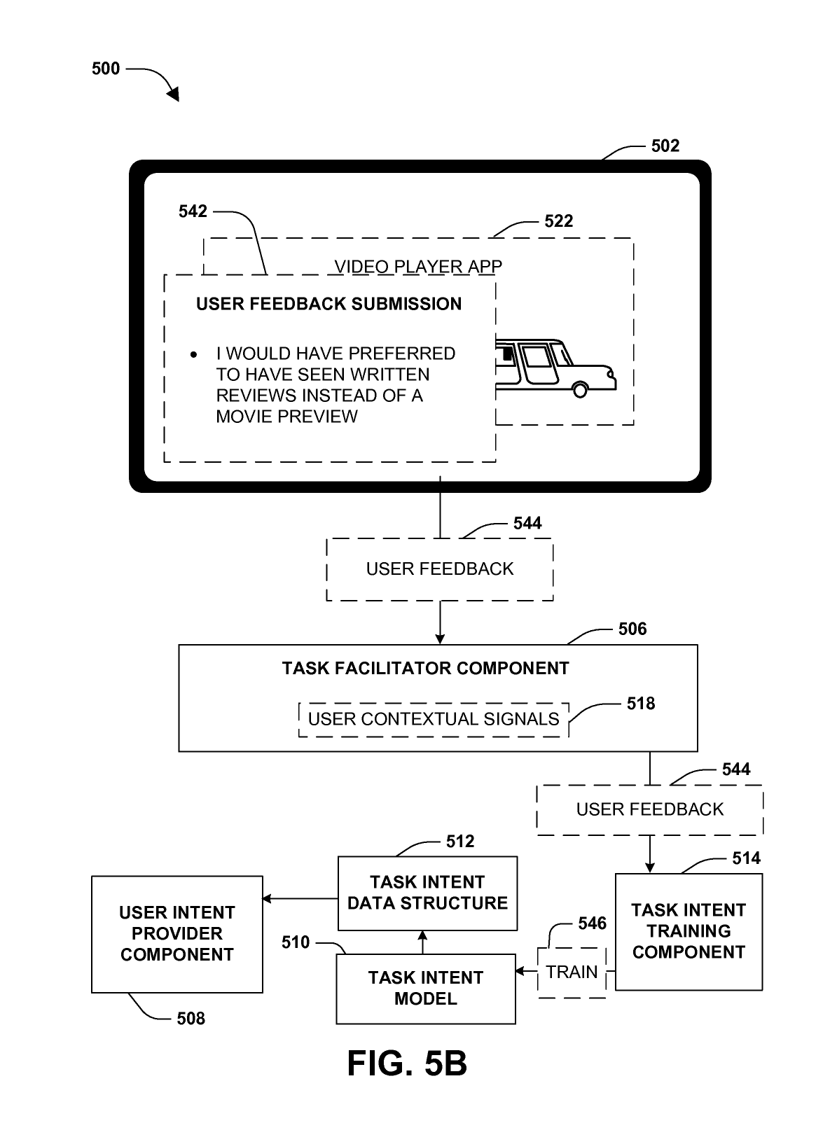

FIGS. 5A and 5B illustrate an example of system 500 for facilitating task completion and utilizing user feedback to train a task intent model 510. The system 500 comprises a task facilitator component 506, a user intent provider component 508, and/or a task intent training component 514. The task facilitator component 506 may receive a natural language input 504 of “movie ideas” from a user of a client device 502. The task facilitator component 506 may construct a user intent query based upon the natural language input 504 (e.g., a movie query). The task facilitator component 506 may send the user intent query to the user intent provider component 508. The user intent provider component 508 may query a task intent data structure 512 using the user intent query to identify a global intent candidate 516 (e.g., a community of users may have played a car racing movie preview after submitting movie type queries). The task facilitator component 506 may evaluate the global intent candidate 516 using a set of user contextual signals 518 (e.g., a video player app 522 may be installed on the client device 502) to identify a user task intent to play a car racing movie preview using the video player app 522. The task facilitator component 506 may expose task completion functionality 520 to the user based upon the user task intent. For example, the car racing movie preview may be played through the video player app 522.

FIG. 5B illustrates the task facilitator component 506 receiving user feedback 544 for the task completion functionality 520. For example, the user may specify through a user feedback submission interface 542 that the user would have preferred to have seen written reviews instead of a movie preview. The user feedback 544 may be provided to the task intent training component 514. The task intent training component 514 may be configured to train 546 a task intent model 510 based upon the user feedback 544, and the trained task intent model 510 may adjust the task intent data structure 512 based upon the training 546 (e.g., one or more query to intent entries may be added, removed, and/or modified, such as an increase to a weight associated with a movie query to read movie review task entry and a decrease to a weight associated with a movie query to play movie preview task entry).

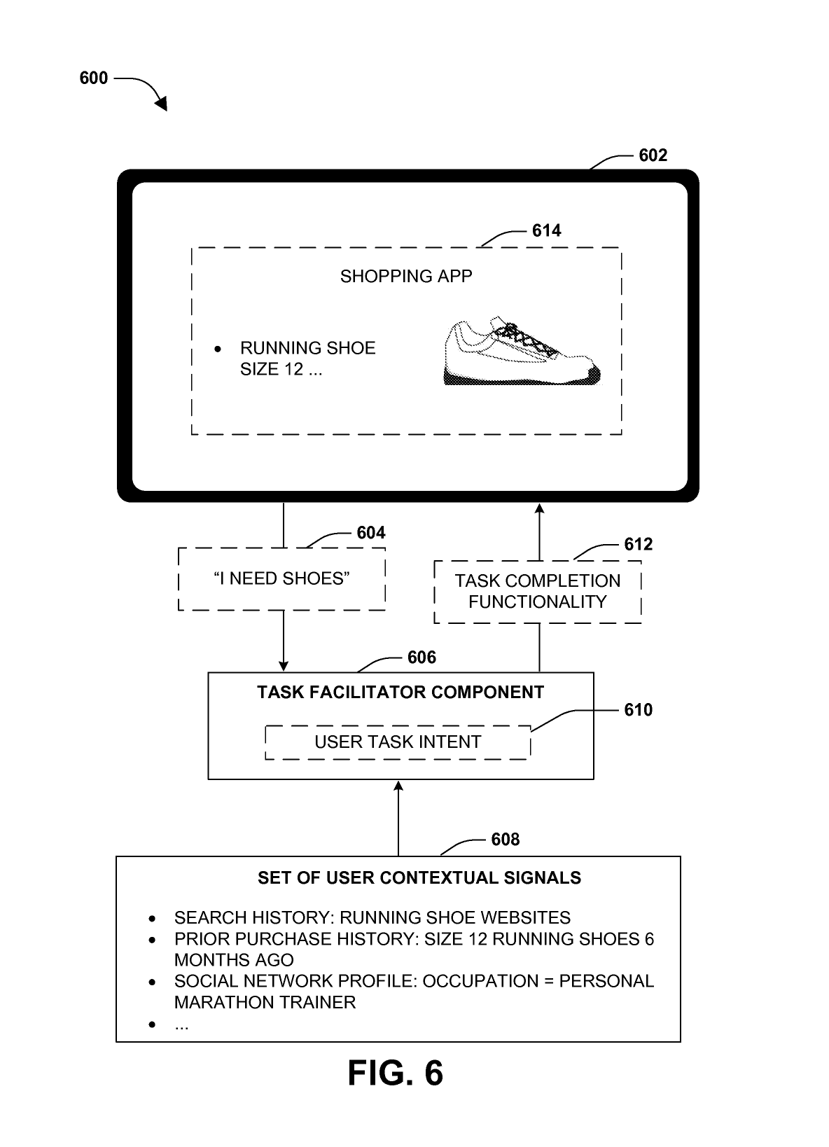

FIG. 6 illustrates an example of a system 600 for facilitating task completion. The system 600 comprises a task facilitator component 606. In an example, the task facilitator component 606 may receive a natural language input 604 of “I need shoes” from a user. The task facilitator component 606 may evaluate the natural language input 604 based upon a set of user contextual signals 608 to identify a user task intent 610. For example, the user task intent 610 may correspond to an intent to buying size 12 running shoes through a shopping app 614 available for download from an app store, which may be identified based upon a search history of the user for running shoe websites, a prior purchase history of size 12 running shoes every 6 months with the last pair being bought 6 months ago, a social network profile indicating that the user is a personal marathon trainer, and/or other user contextual signals. The task facilitator component 606 may expose task completion functionality 612 to the user based upon the user task intent 610. For example, the task facilitator component 606 may download the shopping app 614 (e.g., based upon permission given by the user) from the app store, and may deep launch the shopping app 614 to display size 12 running shoes for sale.

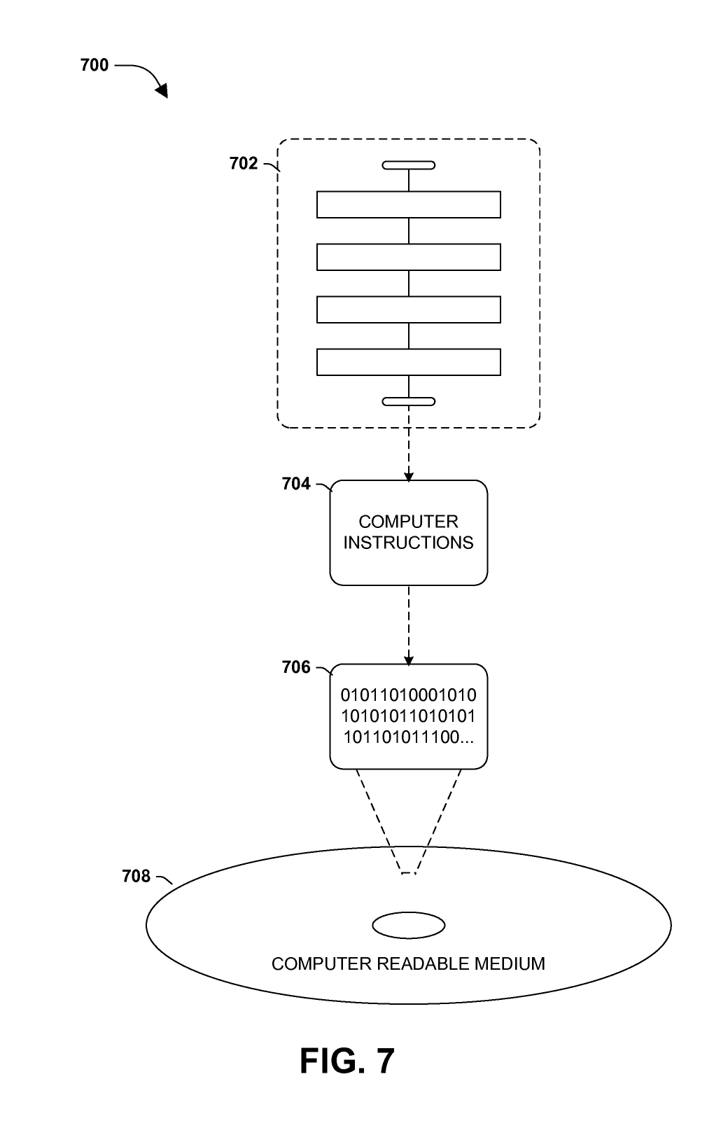

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1, for example. In some embodiments, the processor-executable instructions 704 are configured to implement a system, such as at least some of the exemplary system 200 of FIG. 2, at least some of the exemplary system 300 of FIG. 3, at least some of the exemplary system 500 of FIGS. 5A and 5B, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

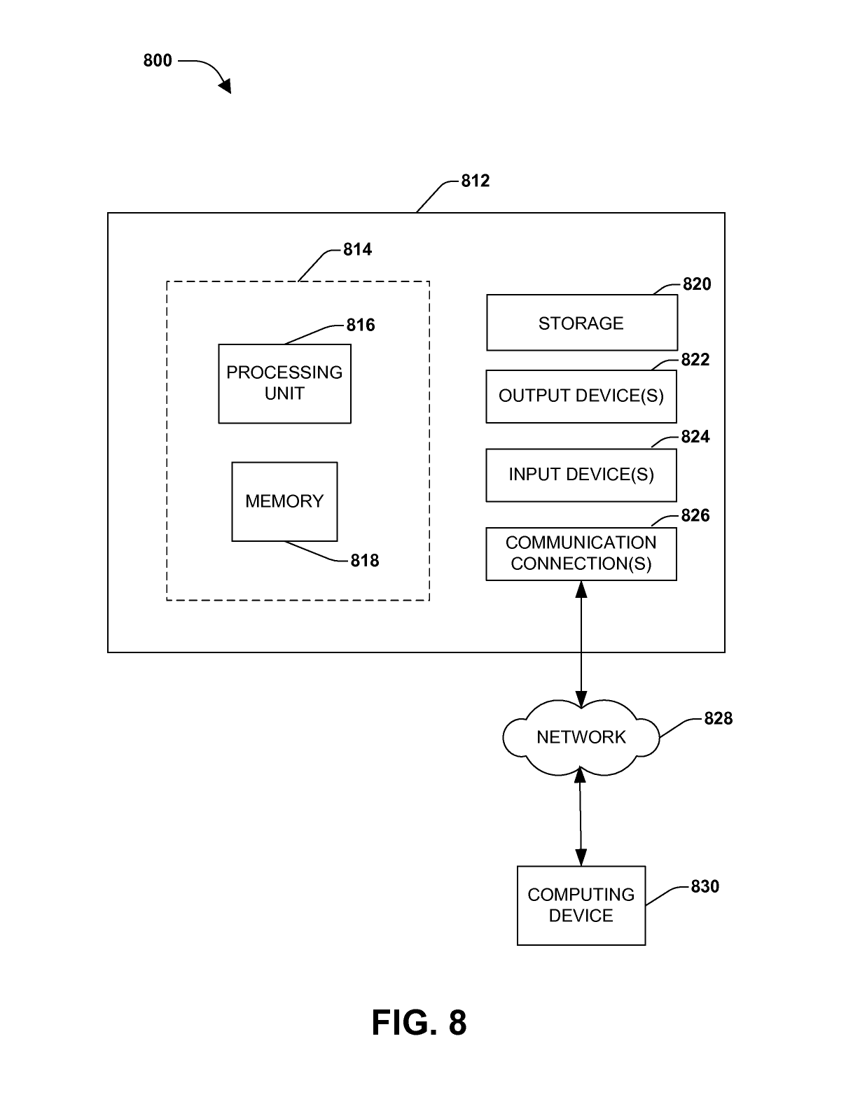

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Computer storage media does not, however, include propagated signals. Rather, computer storage media excludes propagated signals. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for facilitating task completion, comprising:
receiving a natural language input from a user of a client device;
evaluating the natural language input using a set of user contextual signals associated with the user to identify a user task intent; and
exposing task completion functionality to the user based upon the user task intent.

2. The method of claim 1, the exposing task completion functionality comprising:
identifying a task execution context based upon the user task intent, the task execution context comprising an application parameter; and
deep launching an application into a contextual state associated with the task execution context, the application populated with information corresponding to the application parameter.

3. The method of claim 1, the evaluating the natural language input comprising:
constructing a user intent query based upon the natural language input;
querying a task intent data structure using the user intent query to identify a global intent candidate; and
evaluating the global intent candidate using the set of user contextual signals to identify the user task intent.

4. The method of claim 3, the querying a task intent data structure comprising:
sending the user intent query to a server comprising the task intent data structure, the server remote to the client device; and
receiving the global intent candidate from the server.

5. The method of claim 3, the task intent data structure populated with one or more query to intent entries derived from community user search logs.

6. The method of claim 1, the exposing task completion functionality comprising:
executing an application configured to provide the task completion functionality.

7. The method of claim 1, the set of user contextual signals comprising at least one of a geolocation, a time, an executing application, an installed application, an app store application, calendar data, email data, social network data, a device form factor, a user search log, content consumed by the user, or community user intent for the natural language input.

8. The method of claim 1, the exposing task completion functionality comprising:
providing the user with access to at least one of a document, an application, an operating system setting, a music entity, a video, a photo, a social network profile, a map, or a search result.

9. The method of claim 4, comprising:
identifying user feedback for the task completion functionality; and
providing the user feedback to the server for training a task intent model used to populate the task intent data structure.

10. The method of claim 1, the natural language input comprising a voice command provided by the user.

11. The method of claim 1, the exposing task completion functionality comprising:
deep launching an application based upon the user task intent, the deep launching comprising:
identifying a current location of the user;
identifying a set of entity candidates corresponding to the user task intent;
selecting an entity candidate from the set of entity candidates based upon a proximity of the entity candidate to the current location; and
populating the application within information associated with the entity candidate.

12. The method of claim 1, comprising:
providing a user refinement interface to the user based upon the user task intent;
receiving a user task refinement input through the user refinement interface; and
revising the user task intent based upon the user task refinement input.

13. A system for facilitating task completion comprising:
a task intent training component configured to:
evaluate community user search log data to train a task intent model; and
utilize the task intent model to populate a task intent data structure with one or more query to intent entries; and
a user intent provider component configured to:
receive a user intent query from a client device, the user intent query derived from a natural language input received on the client device;
query the task intent data structure using the user intent query to identify a global intent candidate; and
provide the global intent candidate to the client device for facilitating task completion associated with a user task intent derived from the natural language input.

14. The system of claim 13, the task intent training component configured to:
receive user feedback for the global intent candidate; and
train the task intent model based upon the user feedback.

15. A system for facilitating task completion, comprising:
a task facilitator component configured to:
receive a natural language input from a user of a client device;
evaluate the natural language input using a set of user contextual signals associated with the user to identify a user task intent;
identify a task execution context based upon the user task intent; and
deep launch an application into a contextual state associated with the task execution context.

16. The system of claim 15, the task facilitator component configured to:
specify an application parameter for the task execution context; and
populate the application with information corresponding to the application parameter.

17. The system of claim 15, the task facilitator component configured to:
construct a user intent query based upon the natural language input;
query a task intent data structure using the user intent query to identify a global intent candidate; and
evaluate the global intent candidate using the set of user contextual signals to identify the user task intent.

18. The system of claim 17, the task facilitator component configured to:
send the user intent query to a server comprising the task intent data structure, the server remote to the client device; and
receive the global intent candidate from the server.

19. The system of claim 15, the set of user contextual signals comprising at least one of a geolocation, a time, an executing application, an installed application, and app store application, calendar data, email data, social network data, a device form factor, a user search log, content consumed by the user, or community user intent for the natural language input.

20. The system of claim 15, the task facilitator component configured to:
provide a user refinement interface to the user based upon the user task intent;
receive a user task refinement input through the user refinement interface; and
revise the user task intent based upon the user task refinement input.
